(19) United States
(12) Patent Application Publication
(10) Pub. No.: US 2021/0362092 A1
(43) Pub. Date: Nov. 25, 2021

(54) Separation of Hydrogen Isotopes via Plasmonic Heating

(71) Applicant: SAVANNAH RIVER NUCLEAR SOLUTIONS, LLC., Aiken, SC (US)

(72) Inventors: GEORGE K. LARSEN, III, Aiken, SC (US); Simona E. Hunyadi Murph, North Augusta, SC (US)

(21) Appl. No.: 16/880,275

(22) Filed: May 21, 2020

(51) Int. Cl. B01D 59/34; C01B 4/00

(52) U.S. Cl. CPC B01D 59/34; B82Y 30/00; C01B 4/00

(57) ABSTRACT

The present invention is directed to a method of separating hydrogen isotopes. The method comprises: providing an aqueous solution comprising a mixture of hydrogen isotopes comprising a first hydrogen isotope and a second hydrogen isotope and nanoparticles, and exposing the aqueous solution to at least one wavelength of light of the electromagnetic spectrum.

### FEDERAL RESEARCH STATEMENT

This invention was made with Government support under Contract No. DE-AC09-085R22470, awarded by the U.S. Department of Energy. The Government has certain rights in the invention.

This application and technology are controlled pursuant to ECCN 1E001 and 1B231.

### BACKGROUND OF THE INVENTION

As generally known, hydrogen has three naturally occurring isotopes: protium (H2), deuterium (D2), and tritium (T2). Protium is the most common hydrogen isotope, while deuterium is the second most common hydrogen isotope. In many instances, the various isotopes of hydrogen are found as isotopic mixtures. As a result, they are processed for heavy-water production and tritium decontamination. In this regard, various techniques have been utilized in the art in order to separate the various isotopes. For example, these techniques may include, but are not limited to, conventional distillation, sulphide exchange, etc. However, such techniques have various deficiencies and/or disadvantages. For instance, such techniques may be energy intensive, expensive requiring large capital investments, and/or complicated requiring many stages for a desired degree of separation.

As a result, there is a need for an improved method of separating hydrogen isotopes.

### SUMMARY OF THE INVENTION

Aspects and advantages of the invention will be set forth in part in the following description, or may be apparent from the description, or may be learned through practice of the invention.

In accordance with one embodiment of the present invention, a method of separating hydrogen isotopes is disclosed. The method comprises providing an aqueous solution comprising a mixture of hydrogen isotopes comprising a first hydrogen isotope and a second hydrogen isotope and nanoparticles and exposing the aqueous solution to at least one wavelength of light of the electromagnetic spectrum.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates the deuterium content after exposure to the LED light in Example 1;

FIGS. 2A and 2B illustrate the vial before and after exposure to the laser in Example 2;

FIG. 2C illustrates the temperature change of the solution as a function of time based on exposure to the laser in Example 2.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Generally speaking, the present invention is directed to a method of utilizing plasmonic distillation for the separation of hydrogen isotopes in a liquid phase. In general, hydrogen has three naturally occurring isotopes: protium (H2), deuterium (D2), and tritium (T2). In this regard, the present invention may be directed to separating any single isotope from any other isotope or mixture of isotopes. For instance, in one embodiment, the present invention may be directed to separating deuterium, for example from protium and/or tritium. Alternatively, the present invention may be directed to separating protium, for example from deuterium and/or tritium.

In general, the hydrogen isotopes are provided in a liquid phase. For instance, the liquid phase may be water. In this regard, the hydrogen isotopes may be provided in an aqueous solution. In addition, nanoparticles, such as metal nanoparticles, may also be provided in the aqueous solution. By providing nanoparticles within the aqueous solution, the solution may then be exposed to a wavelength of light of the electromagnetic spectrum. Such exposure may allow for the utilization of plasmonic distillation in order to undergo the separation of the hydrogen isotopes. In general, plasmonic distillation is based on photothermal heating with the use of nanoparticles, in particular metal nanoparticles. In general, the metal nanoparticles can absorb light energy, and efficiently convert the light energy to heat (or thermal energy). The generation of the heat can then allow for vaporization and separation.

In this regard, in one embodiment, the present disclosure can be directed to a method of photothermally heating an aqueous solution containing hydrogen isotopes. For instance, the nanoparticles may be employed to transduce heat from light absorption, thereby allowing the nanoparticles to heat solutions. In general, light absorption in nanoparticles is readily dissipated as heat. Without intending to be limited by theory, because of their large absorbance cross-section, plasmonic nanoparticles can generate a significant amount of heat and increase temperatures in their vicinities.

In this regard, the method allows for concentration of a hydrogen isotope by removing another hydrogen isotope. For example, lighter hydrogen isotopes may react or evaporate more quickly than heavier hydrogen isotopes, thereby allowing them to be separated. Accordingly, upon undergoing plasmonic distillation, the aqueous solution may become a concentrated aqueous solution. For instance, the aqueous solution may include a first hydrogen isotope and a second hydrogen isotope. At least one of the isotopes, for example the second hydrogen isotope, is heavier than the first hydrogen isotope. As a result, the concentration of the second hydrogen isotope in the concentrated aqueous solution is greater than the initial aqueous solution. In one embodiment, the concentration of the first hydrogen isotope in the concentrated aqueous solution is less than the initial aqueous solution. Although the aforementioned references a first hydrogen isotope and a second hydrogen isotope, it should be understood that the aqueous solution may also include a third hydrogen isotope.

In the solution, the first hydrogen isotope may be present in an amount of 5 wt. % or more, such as 10 wt. % or more, such as 15 wt. % or more, such as 20 wt. % or more, such as 25 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more, such as 95 wt. % or more, such as 98 wt. % or more, based on the total weight of the hydrogen isotopes. The first hydrogen isotope may be present in an amount of 95 wt. % or less, such as 90 wt. % or less, such as 85 wt. % or less, such as 80 wt. % or less, such as 75 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, based on the total weight of the hydrogen isotopes. In one embodiment, the aforementioned percentages may be for the hydrogen isotopes in the initial aqueous solution. In another embodiment, the aforementioned percentages may be for the hydrogen isotopes after conducting the method and exposing the solution with the light as disclosed herein.

Also, in the solution, the second hydrogen isotope may be present in an amount of 5 wt. % or more, such as 10 wt. % or more, such as 15 wt. % or more, such as 20 wt. % or more, such as 25 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more, such as 95 wt. % or more, such as 98 wt. % or more, based on the total weight of the hydrogen isotopes. The second hydrogen isotope may be present in an amount of 95 wt. % or less, such as 90 wt. % or less, such as 85 wt. % or less, such as 80 wt. % or less, such as 75 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, based on the total weight of the hydrogen isotopes. In one embodiment, the aforementioned percentages may be for the hydrogen isotopes in the initial aqueous solution. In another embodiment, the aforementioned percentages may be for the hydrogen isotopes after conducting the method and exposing the solution with the light as disclosed herein.

By exposing the solution to the wavelength of light, the photothermal heating may result in a vapor being generated. The vapor may include a hydrogen isotope, in particular, the lighter hydrogen isotope of the first and second hydrogen isotopes. Such creation of vapor allows for a concentration of the other hydrogen isotope, in particular, the heavier hydrogen isotope of the first and second hydrogen isotopes, within the bottoms. In a further step, the vapor may be condensed to provide another concentration solution of the lighter hydrogen isotope.

The present inventors have discovered that the method disclosed herein can provide various advantages. For instance, the method and technique can allow for higher separation factors. For instance, the separation factor (as defined by the concentration in the bottoms divided by the concentration in the distillate) is more than 1. In particular, the concentration may be more than 1, such as 1.001 or more, such as 1.005 or more, such as 1.01 or more, such as 1.015 or more, such as 1.02 or more, such as 1.025 or more, such as 1.03 or more, such as 1.035 or more, such as 1.04 or more, such as 1.045 or more, such as 1.05 or more, such as 1.1 or more. The separation factor may be 5 or less, such as 4 or less, such as 3 or less, such as 2 or less, such as 1.8 or less, such as 1.6 or less, such a 1.5 or less, such as 1.4 or less, such as 1.3 or less, such as 1.2 or less, such as 1.15 or less, such as 1.1 or less, such as 1.08 or less, such as 1.07 or less, such as 1.06 or less, such as 1.05 or less. In addition to providing improved separation factors, the method also allows for energy to be used more efficiently than other convention methods of separation.

As indicated herein, the method utilizes nanoparticles, such as metal nanoparticles. In general, the nanoparticles exhibit plasmonic activity and undergo plasmonic heating, in particular when exposed to a given wavelength. For instance, the nanoparticles are capable of converting light energy to heat, thereby allowing for vaporization.

The nanoparticles may not necessarily be limited by the present invention and may include any number of plasmonic materials that may be selected for plasmonic heating of the aqueous solution. In this regard, in one embodiment, the nanoparticles may include a metal nanoparticle, a metal oxide nanoparticle, a metal nitride nanoparticle, etc., or a mixture thereof. In one embodiment, the nanoparticles include metal nanoparticles. In this regard, in one embodiment, the nanoparticles may consist of metal. In one embodiment, the nanoparticles may include gold, silver, copper, palladium, platinum, nickel, titanium, chromium, germanium, tungsten, iridium, aluminum, indium, zirconium, zinc, gallium, etc., or any mixture or alloy thereof. In one particular embodiment, the nanoparticles may include at least gold nanoparticles.

In one embodiment, the nanoparticles may include a metal oxide nanoparticle. For instance, the metal oxide may include iron oxide, aluminum oxide, titanium dioxide, zinc oxide, copper oxide, cerium dioxide, tin oxide, etc., or a mixture thereof. In another embodiment, the nanoparticles may include a metal nitride nanoparticle. For instance, the metal nitride may include aluminum nitride, titanium nitride, vanadium nitride, niobium nitride, molybdenum nitride, gallium nitride, etc., or a mixture thereof. While only certain oxides and nitrides are mentioned, it should be understood that the present invention is not limited. For instance, the metal oxide may include any oxide of the aforementioned metals mentioned above with respect to the metal nanoparticles. Similarly, the metal nitride may include any nitride of the aforementioned metals mentioned above with respect to the metal nanoparticles.

In addition, the nanoparticles may have a particular structure or morphology. For instance, the nanoparticles may be core-shell nanospheres, nanoshells, nanorods, nanocages, nanostars, nanotubes, etc., or a mixture thereof. In one embodiment, the nanoparticles may have a core-shell configuration. For instance, the core-shell configuration may include a core containing silica and a shell including a metal as mentioned above.

In one embodiment, the nanoparticles may have an average diameter of about 5 nm or more, such as 10 nm or more, such as 15 nm or more, such as 17.5 nm or more. The nanoparticles may have an average diameter of about 100 nm or less, such as 75 nm or less, such as 50 nm or less, such as 40 nm or less, such as 30 nm or less, such as 25 nm or less, such as 22.5 nm or less. In one embodiment, the nanoparticles may have an average diameter of from about 5 nm to about 100 nm, such as from about 10 nm to about 75 nm, such as from about 10 nm to about 50 nm, such as from about 15 nm to about 50 nm, such as from about 15 nm to about 40 nm, such as from about 15 nm to about 30 nm, such as from about 15 nm to about 25 nm, such as from about 17.5 nm to about 22.5 nm. The average diameters can be determined using any method known in the art. For instance, the average diameters can be determined by analyzing particle sizes of an SEM image of the nanoparticles. Furthermore, in the instance that the nanoparticles do not comprise nanospheres, and thus do not have a diameter, the aforementioned diameter values may apply to the longest dimension of such nanoparticle.

In one embodiment, the nanoparticles may have an average surface area of about 0.0001 m²/g or more, such as 0.001 m²/g or more, such as 0.01 m²/g or more, such as 0.1 m²/g or more, such as 0.15 m²/g or more, such as 0.2 m²/g or more, such as 0.25 m²/g or more, such as 0.3 m²/g or more, such as 0.5 m²/g or more, such as 0.75 m²/g or more, such as 1 m²/g or more, such as 1.25 m²/g or more, such as 1.5 m²/g or more, such as 2 m²/g or more, such as 3 m²/g or more, such as 5 m²/g or more, such as 7.5 m²/g or more, such as 10 m²/g or more, such as 15 m²/g or more, such as 17.5 m²/g or more, such as 20 m²/g or more, such as 25 m²/g or more, such as 30 m²/g or more, such as 35 m²/g or more. The nanoparticles may have an average surface area of about 200 m²/g or less, such as 150 m²/g or less, such as 100 m²/g or less, such as 50 m²/g or less, such as 45 m²/g or less, such as 40 m²/g or less, such as 35 m²/g or less, such as 30 m²/g or less, such as 25 m²/g or less, such as 20 m²/g or less, such as 15 m²/g or less, such as 13 m²/g or less, such as 10 m²/g or less. The average surface area can be determined using any method known in the art. For instance, the average surface area can be determined using techniques such as a BET analysis.

According to the UV-visible absorbance spectroscopy measurements, a distinctive peak emerges for the nanoparticles indicating a plasmonic peak. In one embodiment, a peak emerges at a wavelength of 400 nm or more, such as 450 nm or more, such as 500 nm or more, such as 510 nm or more, such as 515 nm or more, such as 520 nm or more, such as 525 nm or more, such as 530 nm or more. The peak may emerge at a wavelength of 700 nm or less, such as 650 nm or less, such as 550 nm or less, such as 545 nm or less, such as 540 nm or less, such as 535 nm or less, such as 530 nm or less, such as 525 nm or less. For example, the peak may emerge at wavelength of from 500 nm to 600 nm, such as 500 nm to 550 nm, such as 510 nm to 540 nm, such as 520 nm to 540 nm, such as 525 nm to 535 nm. In particular, in one embodiment, a peak emerges at a wavelength of approximately 532 nm, which matches the localized surface plasmon resonance of the pure gold nanoparticles.

In this regard, in one embodiment, the plasmonic peak of the nanoparticles may overlap the wavelength of light utilized for exposure of the aqueous solution. In one embodiment, the wavelength may be within 25%, such as within 20%, such as within 15%, such as within 10%, such as within 8%, such as within 5%, such as within 4%, such as within 3%, such as within 2%, such as within 1% of the plasmonic peak of the nanoparticle.

The solution may contain nanoparticles as disclosed herein in an appropriate concentration for achieving the desired separation. For instance, in one embodiment, the concentration may be 1×10⁻⁷ M or more, such as 1×10⁻⁶ M or more, such as 1×10⁻⁵ M or more, such as 1×10⁻⁴ M or more, such as 1×10⁻³ M or more to 1×10 M or less, such as 1×10⁻¹ M or less, such as 1×10⁻² M or less, such as 1×10⁻³ M or less. However, it should be understood that the present invention is not necessarily limited by the concentration of the nanoparticles.

As indicated herein, the method comprises a step of at least exposing the aqueous solution to at least one wavelength of light of the electromagnetic spectrum. For instance, the wavelength of light may be from the infrared spectrum, visible light spectrum, and/or the ultraviolet spectrum. For instance, the solution may be exposed to a wavelength of light of from 10 nm to 1 mm. In one embodiment, the solution may be exposed to any wavelength that overlaps with the absorbance of the nanoparticles. In this regard, the photothermal effects can be induced using any such wavelength. As a result, in another embodiment, the solution may be exposed to any wavelength that may not overlap the absorbance of the nanoparticles. Without intending to be limited by theory, it is believed that the heating efficiency is greater when illuminated on resonance.

In addition, any apparatus known in the art may be utilized to supply the particular wavelength of length. For instance, in one embodiment, a laser may be utilized to provide the wavelength of light. In another embodiment, an LED light may be utilized to provide the wavelength of light.

For instance, in one embodiment, the solution may be exposed to at least one wavelength of light from the visible light spectrum. As discussed herein, the visible light spectrum includes wavelengths of from 400 nm to 750 nm. In this regard, the solution may be exposed to a wavelength of light from the visible light spectrum having a wavelength of from 400 nm to 750 nm. In particular, the wavelength may be 400 nm or more, such as 450 nm or more, such as 500 nm or more, such as 510 nm or more, such as 520 nm or more, such as 525 nm or more, such as 530 nm or more. The wavelength may be 750 nm or less, such as 700 nm or less, such as 650 nm or less, such as 600 nm or less, such as 550 nm or less, such as 545 nm or less, such as 540 nm or less, such as 535 nm or less, such as 530 nm or less, such as 525 nm or less.

In another embodiment, the solution may be exposed to a wavelength of light from the infrared spectrum, in particular, the near infrared region. As discussed herein, light from the infrared spectrum has a wavelength of from 750 nm to 2,500 nm. In this regard, the solution may be exposed to a wavelength of light from the infrared spectrum having a wavelength of 750 nm or more, such as 800 nm or more, such as 900 nm or more, such as 1,000 nm or more, such as 1,500 nm or more. The wavelength may be 2,500 nm or less, such as 2,000 nm or less, such as 1,750 nm or less, such as 1,500 nm or less, such as 1,250 nm or less, such as 1,000 nm or less, such as 950 nm or less, such as 900 nm or less.

In another embodiment, the solution may be exposed to a wavelength of light from the ultraviolet spectrum. As discussed herein, light from the ultraviolet spectrum has a wavelength of from 10 nm to 400 nm. In this regard, the solution may be exposed to a wavelength of light from the ultraviolet spectrum having a wavelength of 10 nm or more, such as 50 nm or more, such as 100 nm or more, such as 200 nm or more, such as 250 nm or more. The wavelength may be 400 nm or less, such as 350 nm or less, such as 300 nm or less, such as 250 nm or less, such as 200 nm or less, such as 150 nm or less.

In one embodiment, the solution containing the nanoparticles may be exposed for at least 0.5 minutes, such as at least 1 minute, such as at least 2 minutes, such as at least 3 minutes, such as at least 4 minutes, such as at least 5 minutes, such as at least 10 minutes, such as at least 15 minutes. With the exposure, the bulk temperature of the solution may increase by at least 1° C., such as at least 2° C., such as at least 5° C., such as at least 10° C., such as at least 20° C., such as at least 30° C., such as at least 40° C. and generally 100° C. or less, such as 90° C. or less, such as 80° C. or less, such as 70° C. or less, such as 60° C. or less, such as 50° C. or less, such as 40° C. or less, such as 30° C. or less, such as 20° C. or less, such as 15° C. or less, such as 10° C. or less, such as 5° C. or less. Such exposure may be at any wavelength mentioned above, including wavelengths in the visible light spectrum, infrared spectrum, and/or ultraviolet spectrum.

Furthermore, the method as disclosed herein may be conducted at relatively low temperatures. In one embodiment, the method may be conducted at a temperature of 20° C. or more, such as 25° C. or more, such as 30° C. or more, such as 35° C. or more, such as 40° C. or more, such as 45° C. or more, such as 50° C. or more, such as 60° C. or more, such as 70° C. or more, such as 80° C. or more, such as 90° C. or more. The temperature may be 150° C. or less, such as 130° C. or less, such as 110° C. or less, such as 100° C. or less, such as 90° C. or less, such as 80° C. or less, such as 70° C. or less, such as 60° C. or less, such as 50° C. or less, such as 40° C. or less, such as 30° C. or less. For instance, in one embodiment, the aforementioned temperature may refer to the ambient temperature.

The method as disclosed herein may be utilized in various applications. For instance, these applications may include environmental remediation, nuclear power generation, chemical laboratory analysis, medical diagnostics and imaging, etc. The method may also be utilized by end users that supply heavy water and tritiated water for the laboratory, nuclear, and/or medical fields. Regardless, it should be understood that the method as disclosed herein may be utilized in other applications as well.

### EXAMPLES

### Example 1

In this example, distillation experiments were conducted using gold nanoparticles dispersed in water. The sample contained a natural background deuterium concentration. Three different samples from the same stock solution were measured for the deuterium content after testing.

| | Illumination | | | |
|---|---|---|---|---|
| Sample | Source | Wavelength | Conditions | Observations |
| 1 | LED light (100 | 450 nm for 4 | LED light matched | Temperature |
| | mW/cm²) | hours | plasmonic resonance | increased from |
| | | | wavelength of the gold | 21° C. to 24° C. |
| | | | nanoparticles. | Sample exhibited |
| | | | | steam and |
| | | | | condensation. |
| 2 | LED light (100 | 660 nm for 4 | LED light did not | Temperature of |
| | mW/cm²) | hours | match the plasmonic | the solution did |
| | | | resonance of the gold | not increase |
| | | | nanoparticles. | during |
| | | | | illumination. |
| 3 | None | — | Temperature held at | — |
| | | | 24° C. for 4 hours. | |

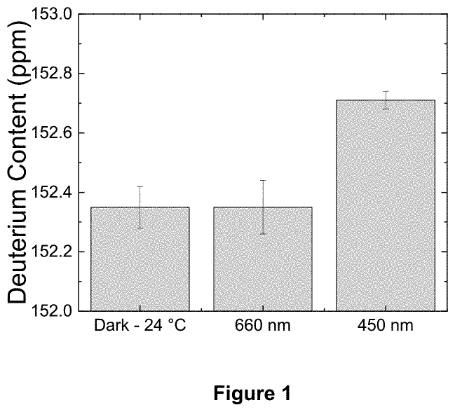

Of the three samples, only Sample 1 demonstrated an enrichment with the heavier isotope. The remaining samples did not appear to demonstrate an enrichment with the heavier isotope. The results are illustrated in FIG. 1, which shows an increase in the deuterium content for Sample 1, exposed to a wavelength of 450 nm wherein the LED light matched the plasmonic resonance wavelength of the gold nanoparticles.

### Example 2

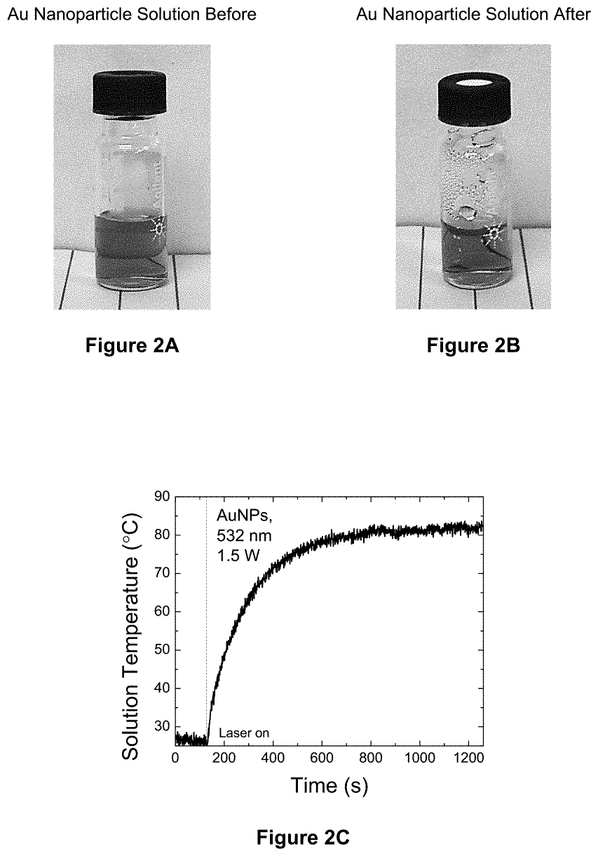

A gold nanoparticle solution in a vial was exposed to a laser at 532 nm. The initial concentration of deuterium in the solution was 153.92±0.07 ppm. After exposure, with the cap removed from the vial, the concentration was 154.42±0.07 ppm. In addition, as illustrated in FIGS. 2A and 2B, condensation was observed inside the vial. Also, FIG. 2C illustrates the increase in temperature as function of time based on exposure to the laser at 532 nm.

### Example 3

A gold nanoparticle solution in a round bottom flask was exposed to a laser at 532 nm. The round bottom flask included a side port which was utilized for a condenser. The initial concentration of deuterium in the solution was 151.8±0.2 ppm. Meanwhile, after exposure to the laser, the distillate contained 146.19±0.03 ppm while the bottoms contained 153.2±0.4 ppm resulting in a separation factor of 1.048±0.003 ppm.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A method of separating hydrogen isotopes, the method comprising
providing a first aqueous solution comprising
a mixture of hydrogen isotopes comprising a first hydrogen isotope and a second hydrogen isotope, and
nanoparticles; and
exposing the aqueous solution to at least one wavelength of light of the electromagnetic spectrum.

2. The method of claim 1, wherein at least one of the first hydrogen isotope or the second hydrogen isotope comprises deuterium.

3. The method of claim 1, wherein at least one of the first hydrogen isotope or the second hydrogen isotope comprises tritium.

4. The method of claim 1, wherein the first hydrogen isotope comprises protium and the second hydrogen isotope comprises deuterium.

5. The method of claim 1, wherein the nanoparticles include metallic nanoparticles.

6. The method of claim 1, wherein the nanoparticles include a metal oxide nanoparticle, a metal nitride nanoparticle, or a mixture thereof.

7. The method of claim 1, wherein the nanoparticles include a metal including silver, copper, iron oxide, palladium, platinum, nickel, titanium, chromium, germanium, tungsten, iridium, aluminum, indium, zirconium, zinc, gallium, or any mixture or alloy thereof.

8. The method of claim 7, wherein the nanoparticles include an oxide or a nitride of the metal.

9. The method of claim 1, wherein the nanoparticles include gold.

10. The method of claim 1, wherein the nanoparticles have an average diameter of from 5 nm to 100 nm.

11. The method of claim 1, wherein the nanoparticles have an average surface area of from 0.0001 m²/g to 200 m²/g.

12. The method of claim 1, wherein the at least one wavelength is in a range of from 400 nm to 750 nm.

13. The method of claim 1, wherein the at least one wavelength is in a range of from 500 nm to 550 nm.

14. The method of claim 1, wherein the at least one wavelength is in a range of from 200 nm to 400 nm or from 750 nm to 2,500 nm.

15. The method of claim 1, wherein the at least one wavelength is within 5% of the plasmonic peak of the nanoparticles.

16. The method of claim 1, wherein the at least one wavelength is within 1% of the plasmonic peak of the nanoparticles.

17. The method of claim 1, wherein the solution is exposed for at least 0.5 minutes and the bulk temperature of the solution increases by at least 1° C.

18. The method of claim 1, wherein the nanoparticles convert light energy to thermal energy.

19. The method of claim 1, wherein the exposing step results in a concentrated aqueous solution.

20. The method of claim 19, wherein the second hydrogen isotope is heavier than the first hydrogen isotope, wherein the concentration of the second hydrogen isotope is greater in the concentrated aqueous solution than the first aqueous solution.

21. The method of claim 20, wherein the concentration of the first hydrogen isotope is less in the concentrated aqueous solution than the first aqueous solution.
